(19) United States
(12) Patent Application Publication
(10) Pub. No.: US 2005/0089828 A1
(43) Pub. Date: Apr. 28, 2005

(54) Language instruction methodologies

(76) Inventor: Ahmad Ayaz, Singapore (SG)

Correspondence Address: CONLEY ROSE, P.C., P. O. BOX 3267, HOUSTON, TX, 77253-3267, US

(21) Appl. No.: 10/679,227

(22) Filed: Oct. 2, 2003

(51) Int. Cl. G09B 19/06

(52) U.S. Cl. 434/157

(57) ABSTRACT

Methodologies of foreign language instruction that help students “relive” a “linguistic childhood”, thus allowing the students to re-adopt techniques that had been quite successful in their first language acquisition. The linguistic input is preferably delivered via different types of dramatic interactions between two “teacher-actors” that are presented live, via multimedia, or via a hybrid of both. The linguistic input preferably includes “high frequency” vocabulary and syntax items. “Comprehension” and “retention” on the part of students represent two significant objectives. Accordingly, the delivery of dramatic interactions is preferably embellished and augmented in a manner to impart “comprehension”, while “retention” is preferably facilitated by configuring the dramatic delivery with a story line for imparting a “heightened experience”, or by including a provision for student participation. Further, the linguistic items are preferably delivered to the students in manageable “doses” that are graded as to be appropriate for the students' level.

### FIELD OF THE INVENTION

The present invention generally relates to methods and arrangements for providing foreign language instruction in a classroom, tutoring and/or multimedia setting.

### BACKGROUND OF THE INVENTION

Numerous foreign (or “second”) language teaching methodologies (i.e., methodologies for teaching a target language to one or more native speakers of a different language) have been proposed and implemented in the past, each ascribing to a given philosophy, academic theory or general approach in attempting to fulfill any of a number of predetermined objectives. (The terms “second language [learning, teaching, acquisition, etc . . . ]” should be understood as being interchangeable herein with the terms “foreign language [learning, teaching, acquisition, etc . . . ]”.)

Whilst some methodologies are intended to teach merely “survival” phrases, e.g., for the occasional traveler, others may be intended to impart, over a given period of time, a native or near-native grasp of the target language. Some methodologies may be intended for students from a variety of different original linguistic or cultural backgrounds, while others may be targeted towards students of a single specific linguistic or cultural background. All in all, the continued advent of greater global cooperation and trade has meant that effective methodologies of foreign language teaching and learning are becoming ever more important, whether in the context of non-English speakers learning English in its role as an increasingly important and visible global lingua franca, or in providing instruction in one or more widespread languages (e.g., Mandarin Chinese, Arabic, or Spanish) associated with regions of increasing economic, political and/or humanitarian importance.

Much research has historically been geared towards ascertaining those factors in a pedagogical setting that are most conducive to assisting a student in optimally internalizing different aspects of the target language. The “Direct Method” of Berlitz and “Audiolingual Method” (or “Army Method”), quite well-known to even casual learners, tend to involve a rote-based, repetitive approach that many have found to be exceedingly emotionless and mechanical. Other, more arcane methods such as “The Silent Way” and “Suggestopedia” exist, with relatively small numbers of followers, primarily because of the use of highly unconventional teaching instruments (e.g. colored rods in “The Silent Way” and classical music in “Suggestopedia”). Methods such as these four have normally been supplanted over time in the face of new research and experimentation.

“Total Physical Response” is quite well-known to a large number of language teachers in its emphasis on directly associating kinetic movements on the part of students with new linguistic items to be learned. However, it tends to fall short in its limited capacity to convey and inculcate more abstract concepts. Finally, the “Natural Approach” of Stephen Krashen has been quite well-known in the academic literature for some years now, and has long appealed to teachers and theoreticians alike for advocating a strong emphasis on internalization of a target language through listening and free conversation. A key element of this methodology (one of five hypotheses, but perhaps the central one) involves providing linguistic “input” to students at least at level (“i+1”) that intentionally presents a bit of a stretch for them. This may well provide a useful starting point in developing new language methodologies, but it does not necessarily provide a complete recipe for optimized instruction. (The terms “student[s]” and “learner[s]” should be understood as being interchangeable herein and can relate to learning in a classroom environment, a one-on-one tutoring environment, via multimedia arrangements, or via any combination of these.)

Many commercially available products employ targeted methods for promoting second language acquisition. For instance, “French in Action” is a set of 24 half-hour lessons of increasing difficulty wherein actors engage in relatively complex dialogs (as compared with the student's likely level of proficiency at that point) that are first played in their entirety without interruption, at full speed, and then are later replayed with opportunities for student repetition. Such dialogs are scarcely different from the type of dramatic presentation that might normally be seen in a TV show or movie targeted at and understood by native or near-native speakers only. Between the two presentations of dialog, there is an extended center section wherein an instructor (the producer of the videos) engages in extensive demonstrations of different linguistic issues associated with the dialog just seen. All discourse is entirely in French. This method can prove to be of an inaccessibly high level to students for whom each respective episode is intended, which could lead to students missing out on retaining various key concepts.

Other language learning methodologies can be gleaned from various issued U.S. patents and published U.S. patent applications. U.S. Pat. No. 5,882,202 (Sameth et al.) relates to a computer-based language learning method wherein a multimedia presentation is employed to teach a foreign language via the display of story-related frames and dialog balloons. A pronunciation guide displays a representation of human lips enunciating selected words or phonemes. U.S. Pat. No. 6,302,695 (Rtischev et al.) contemplates language training via sharing over the internet. Particularly, one or more pre-recorded files that can include phrases or messages in a target foreign language are obtainable over the internet from a “conversation partner”, whereupon the learner can respond to that message (e.g. by repeating the message) and send it to a third party (an “instructor”), who can then provide an “instruction” message relating to an assessment of the learner's attempt to speak in the target language. Both of these approaches, like many others, can tend to provide something of a cold and antiseptic learning environment not readily conducive to meaningful student participation.

It should thus now be appreciated that, despite the numerous historical efforts made towards developing optimized solutions for promoting effective second language instruction and acquisition, room for improvement continually exists. Indeed, many known instruction methodologies do not fully succeed in assisting students in effectively internalizing linguistic properties peculiar to the target language, developing an adequate spoken competence of the target language in a reasonable time frame, and/or breaking down innate “affective barriers” that the student might bear towards learning the target language. Accordingly, an evolving need has generally been recognized in connection with providing methods and arrangements for language instruction that overcome the shortcomings and deficiencies of known methodologies such as discussed heretofore.

### SUMMARY OF THE INVENTION

There are broadly contemplated herein, in accordance with at least one presently preferred embodiment of the present invention, methodologies of foreign language instruction that help students “relive” a “linguistic childhood”, thus allowing the students to re-adopt techniques that had been quite successful in their first language acquisition.

The linguistic input is preferably delivered via different types of dramatic interactions between two “teacher-actors” that are presented live, via multimedia, or via a hybrid of both. The linguistic input preferably includes “high frequency” vocabulary and syntax items. “Comprehension” and “retention” on the part of students represent two significant objectives in at least one embodiment of the present invention. Accordingly, the delivery of dramatic interactions is preferably embellished, or and augmented, in a manner to impart “comprehension”, while “retention” is preferably facilitated by configuring the dramatic delivery with a story line for imparting a “heightened experience”, or by including a provision for student participation. Further, the linguistic items are preferably delivered to the students in manageable “doses” that are graded as to be appropriate for the students' level.

Other refinements and variations on broader concepts associated with embodiments of the present invention will be appreciated from the discussion herebelow.

Generally, there is broadly contemplated in accordance with at least one presently preferred embodiment of the present invention a method of providing instruction of a target language to one or more students whose native language is different from the target language, the method comprising the step of presenting dramatic interactions between at least two teacher-actors, wherein each dramatic interaction: includes pre-scripted dialog primarily in the target language between the at least two teacher-actors, the pre-scripted dialog involving delivery of a plurality of preselected target language items; and includes embellishments to the pre-scripted dialog, the embellishments being adapted to facilitate comprehension of the plurality of preselected target language items on the part of the one or more students; wherein the pre-scripted dialog and embellishments thereto are configured for recreating a learning environment akin to childhood first language acquisition.

Further, there is broadly contemplated in accordance with at least one presently preferred embodiment of the present invention, a multimedia arrangement for providing instruction of a target language to one or more students whose native language is different from the target language, the multimedia arrangement comprising an arrangement for presenting dramatic interactions between at least two teacher-actors, wherein each dramatic interaction: includes pre-scripted dialog primarily in the target language between the at least two teacher-actors, the pre-scripted dialog involving delivery of a plurality of preselected target language items; and includes embellishments to the pre-scripted dialog, the embellishments being adapted to facilitate comprehension of the plurality of preselected target language items on the part of the one or more students; wherein the pre-scripted dialog and embellishments thereto are configured for recreating a learning environment akin to childhood first language acquisition

### Listing of Appendices

To help impart an even better understanding of the embodiments of the present invention, the following Appendices are included herewith:

Appendix A: A sample play entitled “Apple Thief”.

Appendix B: A sample play entitled “Getting Ready for School”.

Appendix C: A sample play entitled “Doctor”.

Appendix D: A sample play entitled “Sandwich”.

Appendix E: A sample play entitled “Blindman's Bluff”.

Appendix F: A sample play entitled “Hot Tea on a Cold Rainy Day”.

Appendix G: A sample set of skits for “Apple Thief”

Appendix H: A sample “Type 1 Display Substitute for Stage Prompter” for “Apple Thief” in the form of a “key language item display”.

Appendix J: A sample “Type 2 Display Substitute for Stage Prompter” for “Apple Thief” in the form of a “beat” transcript.

Appendix K: An illustrated story corresponding to “Apple Thief”.

Appendix M: A tabular listing of similarities between the features of childhood first language acquisition and those of methodologies contemplated herein.

Appendix V: A video compact disc, that can be played on a personal computer in “WINDOWS MEDIA PLAYER”, containing an entire lesson (i.e., play and skits) corresponding to “Apple Thief” in Mandarin Chinese (intended for non-Mandarin speakers).

### DESCRIPTION OF THE PREFERRED EMBODIMENTS

There is broadly contemplated in accordance with at least one presently preferred embodiment of the present invention a language instruction methodology for students of essentially any age group (including adults) that seeks to emulate a student's acquisition of a first language, or to allow the student to essentially re-live a “linguistic childhood” in the target language. This stems from a broad recognition of the efficiency with which children typically acquire their first (native) language, hence the desirability of replicating such efficiency among learners of all age groups.

Though at first sight elusive to define, the concept of a “linguistic childhood”, as well as optimal modes for its promotion, will be better appreciated from the discussion provided herebelow, and particularly from Appendix M, listing similarities between the features of childhood first language acquisition and those of methodologies contemplated herein.

In accordance with a preferred embodiment of the present invention, two techniques of delivering language instruction are broadly contemplated:
“theater of life” plays; and
“reinforcement and expository” skits and visuals.

It will be appreciated from the discussion herebelow that both of the above techniques involve dramatic interactions on the part of at least two teachers serving as actors (thus, “teacher-actors”, a term interchangeable herein with “teachers”) and that these dramatic interactions are presented in a manner (as explained herebelow) to deliver linguistic input (e.g., vocabulary, syntax, etc.) for optimal “comprehension” and “retention” on the part of the student(s).

In this vein, a student's “comprehension” is preferably facilitated through embellishments (or augmentations) to the delivered dialog, such as the use of tangible props (to be manipulated or referred to by at least one teacher-actor or student), visual depictions, sound effects, repetition, exaggerated gesturing and/or exaggerated intonation. (The terms “embellish” and “augment”, as well as their respective grammatical derivations, are used herein interchangeably and are intended to refer to one and the same phenomenon as just defined.)

On the other hand, during the “theater of life” plays “retention” by a student is preferably facilitated through the presentation of linguistic items in the meaningful context of plays with plots and story lines; as will be further appreciated below, the association of a dramatically presented story line with the delivered dialog will provide a heightened experience that will assist a student in long-term retention and future recall. During the “reinforcement and expository” skits, the “retention” is preferably facilitated through the provision of participation in the skits and consequent formation of personal experience with the target language item by the students.

Preferably, both of the above-mentioned techniques involving dramatic interactions will be intermingled in the course of one or more lessons wherein each technique has its own advantages inuring to the benefit of the students' overall learning process. In this vein, the two techniques will preferably “feed into” one another so as to involve a virtually seamless presentation of the instructional material intended to be conveyed.

Generally, the “theater of life” technique is intended to recreate life-like situations in a classroom through “plays” which preferably aim to teach, e.g., between about 10 and about 20 target language items (i.e., vocabulary items), in a story setting. The “reinforcement and expository” skits, on the other hand, normally aim to teach just one target language item at a time in isolated contexts (i.e., without a story setting). As such, the “skits” may essentially be deemed to be very limited and brief “plays” involving just a few dialogs, sometimes even just one. These and other differences between the two types of dramatic interactions will be discussed in more detail herebelow.

Conceivably, lessons can be delivered in any of three manners:
1. “live” instruction (i.e., with teachers and student[s] in the same physical space, such as a classroom);
2. multi-media instruction (e.g., wherein lessons are prerecorded on DVD, video CD [hereafter “VCD”], CD-ROM, etc., and selectively viewed by students on suitable equipment);
3. hybrid instruction, involving both live and multi-media instruction.

There are primarily discussed herein methodologies of the first type, i.e., live instruction, but it should be understood that all three of the above instruction types are not only broadly contemplated herein but involve aspects that are freely interchangeable with other instruction types. Whereas live instruction may well be particularly suitable for children, adults may benefit from instruction via multi-media. Of course, any of the live, multi-media, or hybrid instruction types can easily be tailored to fit the needs of specific age groups.

Multimedia instruction can take place via essentially any suitable arrangement, as presently in existence or yet to be invented, including the internet (e.g., via streaming video), film, or broadcast television, as well as videocassettes, DVD's and VCD's.

Hybrid instruction, for its part, could conceivably involve any reasonable combination of live and multimedia instruction configured for optimal effect or assembled in view of available resources (human or otherwise). For instance, videos, DVD's or VCD's could be used to present “theater of life” plays while “reinforcement and expository” skits could be presented live (i.e., with teachers acting out the skits).

As will be appreciated herebelow, a significant common aspect associated with the delivery of both “theater of life” plays and “reinforcement and expository” skits is in the augmentation (or embellishment) of various aspects of the delivery in an effort to bring about an easily interpretable appreciation and comprehension of the meaning of the new, previously untaught language items. Augmentation, or embellishment, as discussed herein, should be understood to cover what are generally known in the applied linguistic arts as “extra-linguistic clues,” but should also be understood as covering essentially any additive effort, associated with any spoken words or phrases, that aid in interpretation and comprehension of the new, previously untaught language items by the students.

It will be appreciated from the discussion herebelow that plays, through plots, story lines and meaningful contexts thereof (along with embellishments as mentioned heretofore), will provide what can be called “heightened experience” that would facilitate retention of the given language items in the long term memory and their future recall. (See discussion on “elaborative encoding” herebelow.)

Though, as will be appreciated herebelow, skits indeed will not have a story line or plot, they will preferably include other features that will help students retain the new language items that are introduced. One such feature, preferably, is represented by direct student participation that will provide “personal experience” with the new language items.

An overall aim, in accordance with at least one presently preferred embodiment of the present invention, is to provide an intensity of experience in language instruction that helps overcome deficiencies arising from the relatively shorter duration of the learning experience. In other words, the long, drawn-out process that normally constitutes first language acquisition, where the duration of learning over an extended period of time plays a role in promoting the “internalization” of language (e.g., where various vocabulary words are experienced a very large number of times), cannot clearly be replicated with the comparatively limited time available for a typical second or foreign language learning environment (e.g., where vocabulary words might only be heard a few times). (“Internalization” is the process by which the language becomes part of one's nature through unconscious assimilation.) To make up for this virtually unavoidable deficiency, at least one presently preferred embodiment of the present invention aims to essentially imbue the second/foreign language learning process with various measures of intensity, in any of a wide variety of forms such as the meaningful context of the story line in a play and student participation in a skit, sufficient to more firmly inculcate newly taught language items in a manner to optimally promote long-term retention and future retrieval.

Both techniques (i.e., plays and skits as outlined above) aim to promote efficient and effective internalization of a foreign language through well defined and graduated dramatic interactions presented yet in manageable “doses” that are intended not to overwhelm or intimidate students.

At the same time, the conscious teaching of grammar is preferably avoided. As will be appreciated herethroughout, the creation of a learning environment that promotes re-living a “linguistic childhood” will avoid the overt teaching of grammatical principles and structures and instead will aim to help students learn and internalize the target language in a more natural, unconscious manner.

In delivering manageable “doses” of material to students, an English language course may teach about 3000 frequent lexemes. (Lexeme is a meaningful expression in the vocabulary of a language and may include one or more words, wherein for multiple word expressions the individual words do not convey the meaning of the whole [e.g., “war chest”, “give up”].) The course could be divided into five levels. At the average rate of 15 lexemes per play, such a course would have a total of 200 plays. If students attend classes twice a week, at the rate of one play per class, each level with 40 plays can be completed in about 20 weeks (5 months); and the whole course with 200 plays, in 2 years.

Preferably, each individual lesson is made up of one “theater of life” play and a related (i.e., pedagogically consonant) “reinforcement and expository” lesson (i.e., a lesson that is pedagogically consonant with the play and thus contains material to be taught that is analogous or similar to the material taught in the play). The lesson time will preferably be divided into three sessions, starting with a “theater of life” play, followed by a “reinforcement and expository” lesson (skits and visuals, preferably with a pronunciation drill), and thence repetition of the “theater of life” play.

With the above general concepts in mind, “theater of life” plays will first be discussed, followed by “reinforcement and expository” skits and visuals.

“Theater of life” plays are preferably configured to recreate life-like situations, will each preferably aim to make students comprehend the meaning and usage of, e.g., between about 10 and about 20 predetermined new target language items (or “key language items”), which preferably are vocabulary items. On the other hand, syntactic structures of dialogs in a “theater of life” play are appropriately graded for different levels of difficulty in the target language.

Each new, previously untaught key language item is written into the play in a way that ensures: “comprehension” of meaning of the new item through an augmented/embellished mode of delivery of dialogs; and “retention” of the items through the plot, story line and meaningful contexts thereof and, thus, goes beyond mere recitation on the part of instructors.

Several Appendices hereto contain examples of “theater of life” plays in accordance with at least one presently preferred embodiment of the present invention. The characteristics cited above and discussed variously herein will be appreciated from a reading of the plays. The Appendices contain “theater of life” plays as follows:
Appendix A—“Apple Thief”
Appendix B—“Getting Ready for School”
Appendix C—“Doctor”
Appendix D—“Sandwich”
Appendix E—“Blindman's Bluff”
Appendix F—“Hot Tea on a Cold Rainy Day”

As mentioned herebelow, there are also filed herewith the following Appendices corresponding to (and thus presenting content from) the play “Apple Thief”: an Appendix G, containing “reinforcement and expository” skits; an Appendix H, containing a “Type 1 Display Substitute for Stage Prompter” (see below) in the form of a “key language item display”; an Appendix J, containing a “Type 2 Display Substitute for Stage Prompter” in the form of a beat transcript; and an Appendix K, containing an illustrated story. As further mentioned herebelow, there is also filed herewith as Appendix V a video compact disc containing an entire lesson (i.e., play and skits) corresponding to “Apple Thief”.

Since “Apple Thief” on the video disc aims to teach Mandarin Chinese, it is strongly recommended that it be viewed (by a non-Mandarin speaker) prior to any review of the English-language Appendices A, G, H, J and K; in this manner, a non-Mandarin speaker will not be “primed” about the content of the lesson on the video disc and will thus be able to much more readily assess and appreciate the full impact of the teaching methodology presented on the video disc. Of course, once the Mandarin-based video disc has been so viewed, the accompanying Appendices A and G can effectively serve as an approximate (albeit not literal) translation of the Mandarin content.

As can be appreciated from the plays in Appendices A-F, the augmented/embellished aspects of the teachers' delivery may include gestures, intonations, prop manipulation, sensory experiences, etc and/or the repetition of phrases or lines containing “key language items”. (A particularly interesting type of embellishment is the sound effect [auditory sensory experience] used in “Hot Tea” [Appendix C], allowing new, previously untaught words “rain” and “umbrella” to be incorporated into a play without actually “bringing” rain into the classroom.)

It is recognized that “elaborative encoding”, a phenomenon known in applied linguistic arts (and particularly cognitive psychology), facilitates retention and recall of a stimulus (such as, a lexeme) by associating the stimulus with prior knowledge or a meaningful context. In at least one embodiment of the present invention, “elaborative encoding”, such as: embellishments as mentioned heretofore, and heightened and personal experiences (provided through meaningful contexts of the story line of the plays, and individual participation by the students in the skits, respectively) facilitate retention of the given language items in the long term memory and their future recall via multiple cognitive pathways, thus created through said embellishments and experiences in the mind of the students. Thus, “elaborative encoding” compensates for a compromised short duration of experience with the language items in the classroom where long and repetitive experience with the items, as happens during the acquisition of the first language, cannot be provisioned.

For example, in teaching concrete (i.e., tangible, non-abstract) vocabulary, sensory experiences of the students are preferably tapped. Examples of concrete vocabulary are: things that students can see (e.g., cat), taste (e.g., sour), smell (e.g., perfume), hear (e.g., noisy) and touch (e.g., smooth). On the other hand, abstract vocabulary (such as joy, superior, moral, courage) that cannot adequately be deciphered or comprehended merely through a sensory pathway can be taught through on-stage experiences, analogies and metaphors.

In order to create life-like situations, and as a further vehicle for providing embellishments to taught language items, “theater of life” plays preferably make use of toys and household/classroom items as stage props; the off-the-shelf availability of a wide variety of toys in retail stores can provide logistical convenience as well as cost savings in comparison with customized props as typically used in commercial theater, which involve, e.g., sketching, ordering and approving the props, etc. It should be noted that the toys in the “theater of life” plays are usually not used to entertain the students; the toys are merely relatively cost effective and logistically convenient substitutes for custom made stage props. Examples of readily available toy props are found in Table 1. Examples of how toy props could be used in plays are found in Table 2.

TABLE 1

| | Setting | Toys |
|---|---|---|
| Indoors | Kitchen | Stove, pan, pot, ladle, microwave |
| | Ironing | Iron and ironing board |
| | Clinic | Stethoscope, spring-loaded syringe |
| | Shop | Cash Register, trolley |
| Outdoors | Road | Road side cones; motor cars, bikes, |
| | | buses, trucks |
| | Battle | Warrior Set: bow, quiver, spear, |
| | Fields | knife, headgear |
| | | Army Set: Walkie-talkie, helmet, |
| | | grenade |
| | Camping | Camp, glow stars |
| | Fishing | Artificial fish that can swim and |
| | | magnetic fishing rods to catch fish |

TABLE 2

| Play Title | Props |
|---|---|
| Doctor | Toy: Doctor's Box(stethoscope, |
| Story line: Cough patient | pencil light, injection syringe) |
| visiting the doctor; | Cough syrup (coke) in a bottle |
| doctor examining the | (e.g., Coke 390 ml bottle without |
| patient; doctor giving | wrapper); Two small jars each |
| the patient an injection, | with large colored pills, one |
| pills and cough mixture; | color in each jar (M&M candies) |
| payment of the doctor's | Bags for the pills - larger than |
| fee; taking the medicine | usual (e.g., Ziplock) |
| and spitting out | A large ordinary doll |
| | Optional: white coat |
| A Pool in the Room | Kids' vinyl pool that can be |
| Story line: Measuring the | inflated and connected with water |
| depth of the kids' pool, | pipe. |
| a swimming toy, dropping | A toy frog that can swim. |
| and retrieving coins in | Rulers-2 different sizes |
| the pool, selling the | Hand towel-1, floor towel-1, |
| toy, increasing the price | local money |
| and getting robbed | |

To facilitate rehearsal and subsequent performance by the teachers (who often are not formally trained in the art of acting) of the “theater of life” plays, the plays are preferably divided into several “beats”, or shorter segments of dialog, that each contain and emphasize, e.g., between about 1 and about 5 of the key language items. It may be noted that the segmentation of the plays into “beats” need not be noticed by the students watching the play as the transitions from one “beat” to the next should be seamless.

Though “theater of life” plays contain very short and simple dialogs, a capacity for prompting the teacher-actors, at least as a fallback, may still be desirable in the event that a teacher-actor fails to recall any portion of the dialogs. Since cost considerations will likely not warrant the use of a “prompter” (“prompter” is common in amateur theater), prompting could still be effected via relatively inexpensive arrangements.

For instance, a display may preferably be placed in a manner (e.g., on easels) that is visible to the teacher-actors but not to the students. Examples of what may be contained in such a display are shown in Appendices H and J. Appendix H shows a “key language item display”, wherein for a particular play (here, “Apple Thief”), each beat is enumerated along with the key language items to be used for each beat. Accordingly, the teacher-actors will see what key language items correspond to which beat, thus helping them refresh their recall of the lines of dialog associated with each beat. An alternative display is shown in Appendix J, whereby the entire dialog of a beat is displayed to the teacher actors. (A beat sample from a play, again, “Apple Thief,” is shown.) Here, the beat is specially formatted in large fonts with dialogs for the two characters in two different colors (or shades) of text. (The dark vertical bar above “Repeat” shows dialogs that are to be repeated.) It will be appreciated that the use of two different colors in practice (such as red and blue), corresponding respectively to the dialog of the two different teacher-actors, would have a positive practical benefit in providing sufficient contrast between different lines of dialog that is easily discernible from a moderate distance. Of course, the displays contemplated in accordance with Appendices H and J are but illustrative (and non-restrictive) examples; essentially any type of meaningful and helpful display for the benefit of the teacher-actors' recall is conceivable in accordance with the embodiments of the present invention.

Key language items for plays are preferably derived from one or more “high frequency lexeme” lists, as well-known in the applied linguistic arts. (Again, a lexeme is a meaningful expression in the vocabulary of a language and may include one or more words, as discussed further above. Lexemes thus include words, compounds and phrasal verbs.) An employed list of high frequency lexemes will preferably account for an estimated 90% of words in everyday usage. It may be noted that the information on high frequency vocabulary and structure of the language has improved dramatically during the past 15 to 20 years because of the huge computer language corpuses that can be drawn upon. Such corpuses provide not only information on frequency (which is now much more dependable due to the very large size of the corpuses—hundreds of millions of words in English) but also on collocates (i.e., pairs or groups of words that are frequently juxtaposed to an extent much greater than average pairs or groups of words, e.g., “mortgage” collocates with “lend” and “property”) and concordances (i.e., lists of words in a text or groups of texts, with information about where in a text each word occurs and how often it occurs).

Indeed, in order to ensure controlled increase in difficulty levels i.e., systematic sequencing of plays, one may preferably parallel the sequencing with what is known of first (childhood) language acquisition on three levels:
i. Natural order of lexemes
ii. Natural order of language-structure
iii. Complexity of plots of the plays

Though essentially any suitable method or arrangement may be employed to accomplish the above, some useful insights were gleaned from experimentation. Some illustrative and non-restrictive examples from the experimentation are thus discussed herebelow.

To point (i) above, English textbooks used in elementary (primary) grades were collected. Through a computer program, the first occurrence of words in such text books were recorded that were present in the aforementioned list of lexemes. This way, the lexemes were given an “age-mark”. When the same lexeme (denoting the same meaning) occurred at different level of primary books, mix of averaging techniques and discretion was used. The lexemes with a lowest age mark were thus used to write “theater of life” plays for a first level (hereafter “Level One”), with lexemes having gradually increasing age marks were used for “Level Two”, “Level Three”, etc. A primary advantage of using textbooks was that, given how elusive it has been historically to document, in an adequately comprehensive manner, the order in which a child produces words for the first time, the collective knowledge of child textbook curriculum designers could be tapped; such designers have experience in adequately discerning and determining the appropriate grading of lexemes.

To point (ii) above, it is recognized that linguists have recorded the acquisition order of the structure of the language (for example, see, Krashen, Stephen D. and Terrell, Tracy D., “The Natural Approach; Language Acquisition in the Classroom”, Alemany Press 1983). Thus, it came to be appreciated in the aforementioned experimentation that a summary of such an order from various sources (including language curricula that rely on such research), may guide a “theater of life” “playwright” in introducing gradual structural complexity of the target language into the plays.

To point (iii) above, to match the cognitive demands of a “theater of life” plot with the learning levels of students, a profile of children between the ages of 4 and 12 was prepared. The profile was based on the long-term study, of the Gesell Institute of Human Development, of 545 children from stable two-parent families. The profile recorded the following for different ages in sequence: physical development, routines and self-care, emotions, relationships, interests and activities, school life and ethical sense. The insights developed therefrom thus guided the graduated development of each “theater of life” plot; this, especially, is illustrative of how graded and sequenced “theater of life” plays can help a student “relive a linguistic childhood”. (The Gesell studies are detailed in a series of nine books published in the period 1976-1990: “Your Two-Year Old . . . ”, “Your Three-Year Old . . . ”, . . . etc., “Your Ten-to Fourteen-Year Old”; Ames, L. B., et al., authors; Dell Publishing.)

Accordingly, after the list of English lexemes was ready, they were to be used in writing “theater of life” plays. Transforming 3000 English lexemes into “theater of life” plays posed this problem: where and how to start. In order to deal with such a mass of lexemes, the lexemes were grouped under about 1,000 themes (see Table 3) often by referring to thesauruses. Themes themselves were grouped under a broader “umbrella theme” (first and second columns of Table 3).

As shown with an example of umbrella theme and several themes thereunder, the English lexemes were distributed in several columns labeled from Level One to Level Five (though only three levels are shown in the table due to space constraints).

TABLE 3

| Umbrella | | | | Level | |
|---|---|---|---|---|---|
| Theme | Theme | Level One | Level Two | Three | . . . |
| House | Parts of | Door, room, | roof, gate, | fence, | . . . |
| | house | wall, lift | step, lock | entrance, | |
| | | | | lobby | |
| | Rooms | Kitchen, | bedroom | library, | . . . |
| | | bathroom | | study | |
| | Kitchen | Kitchen, tap | sink | Pipe | . . . |
| | Bathroom | Bathroom, | lock, floor, | Pipe | . . . |
| | | tap, mirror, | wall, corner | | |
| | | bath, door | | | |

Each “theater of life” play preferably includes only two characters, though more are conceivable (which would albeit add to costs). This feature is believed to parallel successful acquisition of one's first language, in that one has normally successfully learned his or her native language from two primary caregivers (e.g., two parents). Also, the use of two teachers (and not more) may be preferred for economic reasons (though this, of course, may not be as relevant in the case of multimedia or hybrid instruction types as described above, which would appear to more readily permit the use of more than two teacher-actors since the additional cost would be one-time only, and not recurring as with live instruction).

Preferably, teacher-actors will play the roles of the characters in the plays. Thus, each class will preferably involve two teachers, though more than two are of course feasible (which would albeit add to costs).

The disclosure now turns to “reinforcement and expository” lessons. “Reinforcement and expository” lessons reinforce, confirm and explain the meaning and usage of key language items used in the “theater of life” plays. The students who may not fully comprehend the meaning of a key language item by watching the play will surely understand the meaning through “reinforcement and expository” lessons. Depending on the type of key language item, the “reinforcement and expository” lessons are provided via skits and/or visuals. Further, each “reinforcement and expository” skit or visual may preferably be followed and/or preceded by pronunciation drills.

The “reinforcement and expository” skits can be thought of as rather short, limited plays with just a few dialogs, sometimes just one. As discussed previously, the skits are preferably configured to explain or teach one lexeme in various contexts, and the contexts may or may not be interrelated. Each key language item is preferably acted out through several skits by two teacher-actors. One teacher-actor initiates the skit (“the Initiator”), the other responds (“the Responder”). A sample of such a skit is shown in Table 4. Also, Appendix G contains a full set of skits corresponding to the “Apple Thief” play (Appendix A). It should be noted that the skits, in sum, cover all of the language items from the play. The skits are also present on the video disc submitted herewith as Appendix V, albeit in Mandarin. Thus, it is again strongly recommended that the video disc be viewed first before reviewing Appendix G.

TABLE 4
Reinforcement and expository skit sample

give

[symbol]

Teacher-actor 1: Give me money.
Teacher-actor 2 gives some money from her wallet.

[symbol]

Teacher-actor 1: Give me a pencil.
Teacher-actor 2 gives a pencil to teacher-actor 1.

[symbol]

Teacher-actor 1: Give me your bracelet.
Teacher-actor 2 gives a bracelet to teacher-actor 1.
The students may not understand and/or retain all the words
spoken in a skit. They may hear, as a child acquiring her first
language, does (it is assumed below, for the present discussion,
that students would only understand what a ‘pencil’ is):
Give me blah blah.
Give me pencil.
Give me blah blah.
but they would comprehend “give”.

An important element of a “reinforcement and expository” skit is participation by the students. Almost all key language items have at least one skit with a [symbol] tag. [symbol] stands for “participation”. The [symbol] -tagged skits are suitable for enactment not only between the two teacher-actors but also between a teacher-actor and a student. After all the skits, with and without a [symbol] tag, have been acted out by the two teacher-actors, one teacher-actor preferably withdraws. The remaining teacher-actor assumes the role of initiator and re-enacts the [symbol] -tagged skits with the students. Teacher-actors may certainly exercise some discretion to expand, trim or modify the skits to facilitate effective participation.

To illustrate with an example, in the above skit for “give” in Table 4, a teacher-actor would subsequently turn to an individual student and say, e.g., ‘Give me the book’. (The teacher-actor may have to point towards the book in the event that the student has not yet learned the work “book”.)

Student participation in “reinforcement and expository” skits will preferably be mandatory and (in a classroom setting) one-to-one. If, e.g., a teacher-actor extends a bag of candy and asks, “Do you want candy?”, the student will be compelled to participate, e.g., either by picking up candy or declining by saying, “I don't want candy.” If the student neither speaks nor acts, the interaction obviously fails. (At that point, the teacher-actor will preferably evaluate the causes of the failure and take suitable corrective measures.)

Though any of a wide variety of approaches are conceivable for conducting a “reinforcement and expository” lesson, the following steps are conceivable in accordance with a preferred embodiment of the present invention:
1. A teacher-actor rings a bell and writes a new key language item on board.
2. The teacher-actors conduct a pronunciation drill for the item (see below).
3. Two teacher-actors act out the “reinforcement and expository” skits or show “reinforcement and expository” visuals.
4. One teacher-actor re-enacts the skits with the students.
5. The teacher-actors conduct pronunciation drill again.
The above steps 1-5 for each key language item are repeated.

“Visuals” may be employed in “reinforcement and expository” lessons, especially when a given key language item cannot easily be included as part of a skit or play (e.g., when it cannot easily be employed in natural or prop form, such as “desert” or “river”; or e.g., when it requires more than two characters, such as “crowd”). “Visuals” in this context represent key language items and are preferably concerned mostly, though not exclusively, with nouns. This may be carried out to great effect by taking advantage of the power of internet image search engines, and affordable PC and multimedia projectors, by searching, storing, and later, projecting images in the classroom. Some examples of nouns that may benefit from such treatment are:
words for outdoor locations, such as: beach, desert, forest, highway; and
collective nouns, such as: crowd, riot, rally, meeting

For instance, in teaching the word ‘beach’, a search for ‘beach’, ‘Hong Kong beach’, ‘Japan beach’ or ‘Mumbai beach’ on an internet image search engine would yield several images of beaches, including those in Hong Kong, Japan or Mumbai. Several representative images, including local ones, could thus be chosen and stored in memory prior to the class and shown to the students during the class.

Finally, pronunciation drills could be employed to enhance the impact of the “reinforcement and expository” lessons. The importance of this of course varies depending on the degree of divergence between the phonetic system of a student's native language and that of the target language, and on a student's ability to distinguish and produce sounds in general. In situations where the phonetic system of the target language has the potential to present difficulties regardless of the cause(s), and a student may not perceive and/or produce sounds or phonemes (phonemes are the smallest units of speech that can differentiate one word from another) of the target language correctly, pronunciation drills could be of great assistance.

Thus, a pronunciation drill is preferably held before and after each “reinforcement and expository” skit and the display of each “reinforcement and expository” visual. A teacher-actor preferably writes one key language item on the whiteboard and enunciates it loudly. For an item that students find difficult to pronounce, the teacher-actor splits it into its constituent syllables or phonemes and enunciates it forward and backward. The students collectively, and, where need be, individually repeat the item after the teacher-actors.

If the students in the class are from just one linguistic background (e.g., all are native Mandarin speakers), preferably one of the two teacher-actors in the classroom could be someone well-versed in both the student language and the target language. The bilingual teacher-actor can anticipate and appreciate the problems of the students, that might occur (especially during pronunciation drills and student-participatory phases of the skits) in the areas of pronunciation and syntax, better than, e.g., a monolingual native speaker can.

The phenomenon of “transfer”, wherein a student's knowledge of his/her native language (“L1”) colors different aspects of his/her acquisition of a second, or target, language (“L2”) is well documented in linguistic literature. A few examples for syntax and pronunciation may illustrate the advantage of a linguistically mixed pair of teacher-actors as discussed above (Table 5).

TABLE 5

| First | | | |
|---|---|---|---|
| Language | What is said | What is meant | Cause |
| Chinese | Let's eat | Let's have a | Chinese term for meal |
| | rice | meal together. | and rice is same, ‘fàn’ |
| | together. | | |
| Hindi | Leave my | Let go of my | One of the meaning's of |
| | hand. | hand. | the Hindi equivalent of |
| | | | ‘leave’ is ‘let go’ |

Not all languages, of course, have similar sounds, similar sound combinations or same sound positions (finals or initials). For example, English speakers have difficulty in pronouncing several sounds of Mandarin; Hindi speakers may not distinguish between the sounds of /v/ and /w/. See the discussion of pronunciation drills, below, for an expanded discussion on the issue.

It should thus be appreciated that a bilingual teacher-actor would possess knowledge about such differences in syntax and pronunciation, appreciate the prospective difficulties students may face and thus could be in a position to suggest efficient solutions.

Reading may be introduced to students via the display of key language items on a board in live instruction, or via the display of titles or subtitles corresponding to key language items in multi-media instruction. Also, in accordance with at least one embodiment of the present invention, the students may be provided with reading assignments in the form of illustrated stories which highlight the key language items that they have been taught. An example of such a story is shown in Appendix K in a sequential page format. For live or hybrid instruction, such stories may be assigned to be taken home, while for multimedia instruction, such stories may be provided as supplementary material that students may peruse on their own time. An advantage of such stories would be that they introduce a more narrative language style, as opposed to the conversational style used in the plays and the skits. Further, since the stories will not have as many embellishments or extra-linguistic clues as were present in the plays and the skits, the students will be availed of the opportunity to essentially perform a self-check on their memory and comprehension of the language items learned in class.

By way of summary, in an effort to help impart a yet better understanding to the concept of reliving a “linguistic childhood”, Appendix M illustrates similarities between typical L1 (first language) acquisition and the inventive methods as contemplated herein (in accordance with at least one presently preferred embodiment).

Included with the instant application, as Appendix V, is a video compact disc containing an entire lesson (“Apple Thief”) in Mandarin involving both a “theater of life” play and “reinforcement and expository” skits. The compact disc, which can be played in “WINDOWS MEDIA PLAYER” on a personal computer, will help impart an even better appreciation of the present invention in accordance with at least one presently preferred embodiment thereof. (It should be noted that the disk does not include pronunciation drills and has no provision for participation by viewers, but still includes a full play and skits.) Again, it is strongly recommended that this disc be viewed before reviewing any of the “paper” appendices corresponding to “Apple Thief” in English (i.e., Appendices A, G, H, J and K).

Though Appendices A, B, C, D, E, F, J and K are all presented herewith in black and white format, it should be appreciated that they are all readily presentable in color format. Particularly, as stated earlier, Appendix J (or any “beat” transcript) can easily be presented in a color format wherein alternating lines of dialog, corresponding to dialog from each of the two teacher-actors, can be presented in different colors such as red and blue. A similar principle can thus be applied to the lines of the plays presented in Appendices A, B, C, D, E and F (or any play). Further, Appendix K (or any illustrated story) may easily be presented in a color format to enhance a student's appreciation and enjoyment of the story.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein.

It should be appreciated that the apparatus and method of the present invention may be configured and conducted as appropriate for any context at hand. The embodiments described above are to be considered in all respects only as illustrative and not restrictive. All changes which come within the meaning and range of equivalency of the claims are to be embraced within their scope.

APPENDIX A
Apple Thief

| | |
|---|---|
| Story Line | Apple theft, recovery and sharing |
| Characters | Two sisters |
| Story | A girl (“Thief”) steals an apple. Her sister, the owner |
| | (“Owner”) locates her and asks her to return the apple. Thief |
| | runs away. Owner chases and catches Thief and they struggle. |
| | Thief realizes that she has no choice but to give the apple |
| | back. So she does but charms the Owner to share the apple. |
| | Owner agrees and attempts to slice the apple with a real tiny |
| | knife and then a big plastic knife but fails. Thief tries and |
| | succeeds in cutting the apple and gives small pieces to Owner. |
| | After Owner has had enough, Thief forces her to eat more. |
| | Owner gets annoyed and runs away. Thief gets rest of the |
| | apple! |
| Props | Real apple (or a fruit with firm flesh e.g., guava, pear), tiny |
| | real folding pocket knife (or a nail cutter with knife), large |
| | plastic toy knife |
| Run Time | 7.5 minutes |
| Key items | Beat1: apple, what, mine |
| | Beat2: give me, no |
| | Beat3: let go |
| | Beat4: you, take it |
| | Beat5: want, yes |
| | Beat6: cut, some |
| | Beat7: small knife, big knife, cannot |
| | Beat8: cannot, try again |
| | Beat9: for you, thank you |
| | Beat10: enough, don't want |
| | Beat1: apple, what, mine |
| | Thief walks in with an apple. |
| | Owner follows looking for something, spots Thief and |
| | the apple in her hand. Owner's face brightens. |

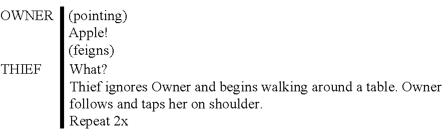

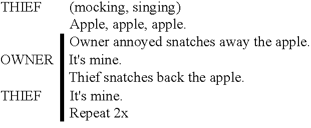

Beat2: give me, no
Thief has the apple. She starts walking around the table,
trying to get away. Owner stops her.

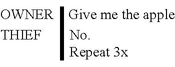

| | |
|---|---|
| OWNER | (suddenly screams) |
| | Give me, give me, give me the apple |
| THIEF | (screams back) |
| | No, no, no. |
| | Beat3: let go |
| | Thief starts running around the table. Owner chases. Suddenly |
| | owner reverses direction and catches Thief's hand tight. |
| | But Thief is holding the apple in the other hand. |

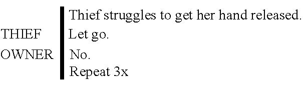

Owner tries to reach for the apple in Thief's other hand.
Thief pulls away her hand.

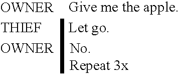

Beat4: you, take it
Owner gets a grip of Thief's second hand. Now the two
struggle for the apple with both hands.

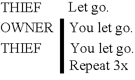

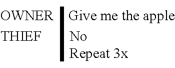

| | |
|---|---|
| | (hand on hips, screams) |
| OWNER | Give me the apple. |
| | Thief is a little scared. They stare at each other for 3-4 |
| | seconds. |
| THIEF | Ok, take it. |
| OWNER | (surprised, happy, suspicious) |
| | What! |
| THIEF | Take it. |
| OWNER | (still suspicious) |
| | Really? |
| THIEF | (assures) |
| | Take it. Take it. |
| | Owner takes back her apple. |
| | Beat5: want, yes |
| | Owner strolls around the table - happy, playing with |
| | the apple. Thief turns friendly. |

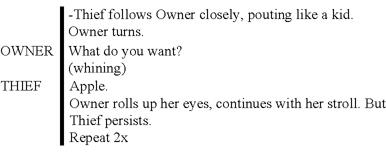

| | |
|---|---|
| | Owner melts. Strokes Thief's head. |
| OWNER | You want the apple? |
| THIEF | (pouts, nods) |
| | Yes, I want the apple. |
| OWNER | You want the apple? |
| | (pouts, nods) |
| THIEF | Yes. |
| OWNER | You want the apple? |
| | (pouts, nods) |
| THIEF | Yes, yes. |
| | Beat6: cut. some |
| | Owner makes a cutting gesture on the apple. |
| OWNER | OK,let me cut it. |
| | (repeats cutting gesture, puzzled) |
| THIEF | Cut it? |
| OWNER | Yes, cut it. |
| | (still puzzled) |
| THIEF | Cut it? |
| OWNER | (explains) |
| | I will give you some. |
| THIEF | You will give me some? |
| OWNER | Yes, I will give you some. |
| | Beat7: small knife, big knife. cannot |
| | Owner takes out a tiny knife and holds it up. |
| THIEF | You have a knife! |
| OWNER | Yes, I have a knife. |
| | The knife is tiny. Owner tries to cut the apple but fails. |

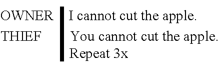

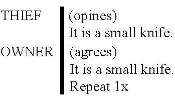

| | |
|---|---|
| | Thief pulls out a big (plastic) knife. |
| THIEF | I have a big knife. |
| OWNER | Wow, you have a big knife. |
| | (brandishes knife) |
| THIEF | I have a big knife. |
| | Beat8: cannot, try again |
| | The plastic knife is large but blunt and useless. Owner |
| | cannot cut the apple. |

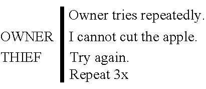

| | |
|---|---|
| OWNER | (frustrated) |
| | You try it. |
| | Owner hands over the knife and apple to Thief. |
| THIEF | OK |
| | Beat9: for you, thank you |
| | Thief tries but cannot cut the apple either. |
| THIEF | I cannot cut the apple. |
| OWNER | You cannot cut the apple. |
| | Thief gives back the big knife and picks up the small knife |
| | from the table. |
| THIEF | I don't want the big knife. I want the small knife. OK? |
| OWNER | OK |

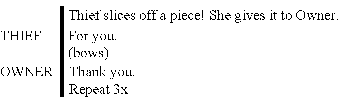

| | |
|---|---|
| | Beat10: enough, don't want |
| | Owner has had enough. She belches and pushes away |
| | Thief's hand. |
| OWNER | Enough. |
| | Thief puts the piece in her mouth |
| THIEF | For you. |

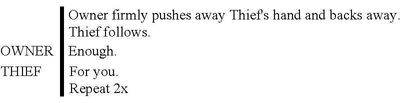

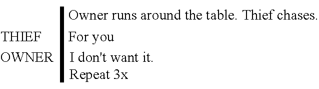

| | |
|---|---|
| | Owner exits. Thief comes back to the centre. Pats her |
| | chest with the apple few times, laughs, tosses it up |
| | few times and says repeatedly |
| THIEF | MY apple. |

THE END

APPENDIX B
Getting Ready for School

| | |
|---|---|
| Story Line | Lost sock, loose belt, tight necktie, Cola and milk |
| Characters | Mom and son |
| Story | A boy while getting ready for school wears two socks on one |
| | foot and then asks her Mom for the other sock. Mom tells him |
| | to wear his belts and help him with his tie. When she goes to |
| | take socks for him, he switches cup of milk with cup of Cola. |
| | Mom gets fooled but when she discovers the two socks on one |
| | foot, she cannot help laughing, much to the chagrin of his son. |
| Props | Two identical opaque cups, small milk carton/bottle, cola can, |
| | (optional: school uniform type clothes, school bag) |
| Run Time | 5 minutes |
| Key Items | Beat1: Mom, socks, don't know |
| | Beat2: belt, don't like, don't do that |
| | Beat3: wear, loose |
| | Beat4: tie, tight, still, now |
| | Beat5: milk, drink, cola |
| | Beat6: finished, good boy |
| | Beat7: take off, laugh, foot |

| | |
|---|---|
| | Beat1: Mom, socks, don't know |
| | Enters a boy, half dressed in a school uniform. He has white |
| | shorts and shirt on. The shirt is only half tucked in. He is |
| | holding a belt in his hand and he is wearing only one sock. |
| BOY | (increasingly louder) |
| | Mom, Mom, Mom |
| | Enters Mom, stands behind quiet letting him call her few times. |
| | Mom is holding an empty cup and a small milk pack/bottle. She |
| | puts the cup and the milk pack on the table. |
| MOM | Yes? |
| | (raises the bare foot) |
| BOY | My socks? |
| MOM | (points to the clad then barefoot) |
| | Only one sock! Where is the second sock? |
| BOY | (shrugs) |
| | I don't know. |
| MOM | You should know. |
| BOY | (shrugs) |
| | I don't know. |
| MOM | You don't know? |
| BOY | (shrugs) |
| | I don't know. |
| | Beat2: belt, don't like, don't do that |
| | Mom notices the belt in his hand. |
| MOM | Your belt. |
| BOY | Oh belt? |

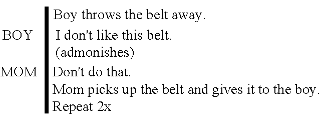

| | |
|---|---|
| | The boy tries to throw the belt again but stops ... |
| BOY | I don't like this belt. |
| | (hollers) |
| MOM | Don't. |
| | Beat3: wear, loose |
| | Mom takes the belt back. |
| MOM | Why? Why don't you like it? |
| BOY | This belt is loose. |
| | Mom ignores his complaint, puts the belt around the |
| | boy's waist but does not buckle it. She tugs at the belt. |

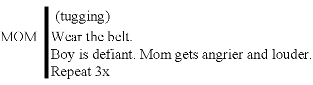

| | |
|---|---|
| BOY | (shrugs) |
| | Ok, I will wear the belt. |
| | Boy buckles the belt very loose. He tugs at the fastened |
| | belt and tucks in his tummy to make his point. |

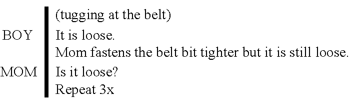

| | |
|---|---|
| BOY | It is not loose. It is okay. |
| | Beat4: tie, tight, still, now |
| | Now, it's the turn of tie hanging loosely around Boy's neck. |
| MOM | (points) |
| | Your tie. |
| BOY | My tie? |
| MOM | Yes, your tie. |
| | Mom goes near and tightens it. |
| BOY | (chokes, coughs) |
| | It is very tight. |

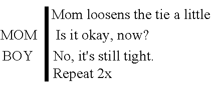

| | |
|---|---|
| MOM | Now? |
| | Boy moves the tie loop around his neck. |
| BOY | Ok now it is okay. |
| | Beat5: milk, drink, cola |
| | She pours the milk into glass. She offers the glass to the boy. |
| MOM | Milk for you. |
| | Boy remembers his sock. |

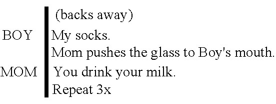

| | |
|---|---|
| MOM | (gives in) |
| | Ok I will get the socks. |
| | Mom exits. |
| BOY | (to the audience) |
| | Milk - yuck. I don't like milk. |
| | Boy spots and picks up a can of cola, chuckles, raises it. |
| BOY | I like cola. |
| | He pours some cola into another identical cup. Puts |
| | away the can and the cup with the milk. Dances, winks, |
| | puts his finger on lips and tells the audience ... |
| BOY | Don't tell. |
| | Beat6: finish d, good boy |
| | Mom returns, holding the socks separately in two hands. |
| MOM | Your socks |
| BOY | (chest puffed, head high) |
| | Mom, I am drinking milk. |
| MOM | Oh, ok - you are drinking milk! |
| | (smacks lips) |
| BOY | Yes, I like milk. |
| MOM | (puzzled) |
| | You like milk? |

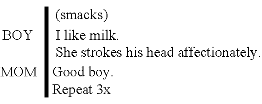

| | |
|---|---|
| | Boy empties the cup, holds it upside down and bangs it on the |
| | table. |
| BOY | Finished! |
| MOM | Finished? |
| | (picks up the cup, shakes it upside down) |
| BOY | Yes, finished. |
| | Beat7: take off, laugh, foot |
| MOM | Now, take off your sock. |
| | Boy throws himself on the sofa, raises his clad foot. |
| BOY | You take off the sock. |
| MOM | Ok, I will take off the sock. |
| | Mom takes the sock half off and discovers two socks on |
| | one foot! She holds up his foot with two socks. |
| MOM | Here are the two socks. |

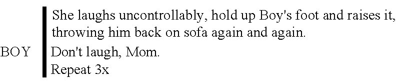

| | |
|---|---|
| MOM | (cups her mouth) |
| | Ok, I will not laugh. |
| | He yanks his foot, massages his foot. |
| BOY | Ah, my foot. My foot. |
| MOM | Give me your foot. |
| | He extends a foot. Mom puts on socks on one foot. |
| MOM | (points to another foot) |
| | Give meyourfoot. |
| | Mom puts on socks on the other foot. |
| | Boy puts on shoes, grabs the school bag and exits. |
| BOY | Bye, bye, Mom. |

THE END

APPENDIX C
Doctor

| Story Line | Cough patient visiting the doctor, doctor examining her, |
|---|---|
| | giving her an injection, pills, cough mixture, payment of the |
| | doctor's fee, taking the medicine and spitting out |
| Characters | Doctor, patient |
| Story | A woman goes to see a doctor with her doll. The woman has |
| | cough. Doctor listens to her chest and back, examines her |
| | throat and takes her temperature. He gives her an injection, |
| | some pills and cough mixture. Doctor charges ten dollars as |
| | fee. Outside the clinic, the woman gets a coughing fit and |
| | takes the medicine. She finds it very bitter and almost throws |
| | it away. |
| Props | Child's Doctor's Box (stethoscope, pencil light, injection |
| | syringe) Cough syrup (coke) in a bottle (e.g., Coke 390 ml |
| | bottle without wrapper) |
| | Two small jars each with large colored pills, one color in each |
| | jar (M&M candies) |
| | Bags for the pills - larger than usual (e.g., Ziplock) |
| | A large ordinary doll |
| | Optional: white coat |
| Run Time | 4 minutes |
| Key Items | Beat 1: hello, doctor, sit down |
| | Beat 2: cough, turn around |
| | Beat 3: open, close, mouth, say |
| | Beat 4: don't talk |
| | Beat 5: injection, hurt (feel pain) |
| | Beat 6: pill, mixture (cough mixture) |
| | Beat 7: fee, bye, numbers 1-5 |
| | Beat 8: bitter, also, take (eat) |
| Special | Don't share cola or candies with the audience before or |
| Note | after the play. They should believe that it is medicine. |
| | Beat 1: hello, doctor, sit down |
| | - A doctor in a white coat sitting at a table. We can |
| | see a stethoscope, pencil light, injection syringe, a |
| | bottle with cough mixture and two jars with pills. |
| | - Enters a patient holding her daughter (the doll). The |
| | patient pauses, looks at the doctor, coughs and |
| | sneezes into a tissue paper. |
| DOCTOR | Oh, hello. |
| PATIENT | (sniveling) |
| | Hello, doctor. |
| | 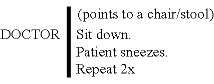 |
| | Patient sits down. |
| PATIENT | (pointing to doll) |
| | This is Jane [substitute local name] |
| DOCTOR | Hello, Jane. |
| | (to the doll) |
| PATIENT | Say, hello. |
| | Beat 2: cough, turn around |
| DOCTOR | Yes? |
| PATIENT | (gets a coughing fit) |
| | Doctor, I have a cough. |
| DOCTOR | Yes, you have a cough. |
| PATIENT | Bad cough. |
| DOCTOR | Yes, bad cough. |
| PATIENT | Very bad cough. |
| DOCTOR | Very bad cough. |
| | Doctor picks up the stethoscope. |

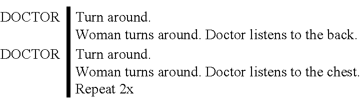

Beat 3: open, close, mouth, say
Doctor puts the stethoscope away, scribbles some
note and picks up the pen light.

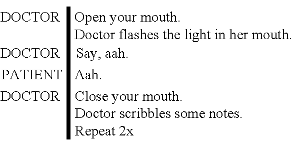

| | |
|---|---|
| | Beat 4: talk (don't talk) |
| | Doctor puts away the pen light and gets the thermometer. |
| DOCTOR | Open your mouth. |
| | Doctor puts the thermometer in her mouth. |

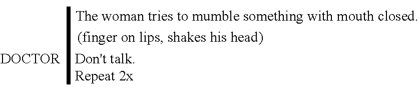

| | |
|---|---|
| | Doctor takes the thermometer from her mouth. |
| | She is annoyed at getting scolded. |
| | (mimics to the audience) |
| PATIENT | Don't talk. Don't talk. |
| | Beat 5: injection, hurt (feel pain) |
| | Doctor picks up the syringe and holds it up. |
| DOCTOR | I will give you an injection. |
| | (in horror) |
| PATIENT | Injection? |
| DOCTOR | Yes, injection. |
| PATIENT | (shakes) |
| | No, no. |
| DOCTOR | (nods) |
| | Yes, yes. |
| | (feebly) |
| PATIENT | No. |
| | (firmly) |
| DOCTOR | Yes. |
| | She extends her arm, face towards the audience, eyes |
| | closed. Doctor gives the injection. She winces in pain. |
| PATIENT | Ouch. It hurts. ... It hurts. ... It hurts. |
| DOCTOR | Done. |
| | Woman strokes her arm. |
| | Beat 6: pill, mixture (cough mixture) |
| | Doctor takes out some pills from each jar. Puts them |
| | in two separate bags. |
| | (handing over the bags) |
| DOCTOR | Pills for you. |
| PATIENT | Pills? |
| DOCTOR | Yes, pills. ... Green pills. ... Red pills. |
| | Pours the cough mixture into a vial. |
| DOCTOR | This is cough mixture. |
| PATIENT | Cough mixture? |
| DOCTOR | Yes, cough mixture. |
| | Beat 7: fee, bye. numbers 1-5 |
| DOCTOR | (extends his hand) |
| | My fee - ten dollars [substitute local currency] |
| PATIENT | Oh, your fee. |
| DOCTOR | Yes, my fee-ten dollars [substitute local currency] |
| | Patient takes out the money and hands over one by one. |
| PATIENT | One, two, three, four, five. Your fee. |
| DOCTOR | (counts again) |
| | One, two, three, four, five.... My fee is ten dollars. |
| | Patient takes out more money, counts herself. |
| PATIENT | One dollar, two dollars, three dollars, four dollars |
| | five dollars. |
| | (counts) |
| DOCTOR | One dollar, two dollars, three dollars, four dollars, |
| | five dollars. |
| PATIENT | Okay? |
| DOCTOR | Okay. |
| | (waves) |
| PATIENT | Bye bye. |
| DOCTOR | Bye bye. |
| | (to the doll) |
| PATIENT | Say bye. |
| DOCTOR | Bye bye. |
| | Beat 8: bitter, also, take (eat) |
| | Patient walks out, gets a coughing fit and stops. |
| | Takes out a green pill. |
| PATIENT | Let me take this pill. |
| | She puts the pill in her mouth, chews, and spits out |
| | into a tissue in disgust. |
| | (grimacing, to the audience) |
| PATIENT | It is bitter - very bitter. |
| | Takes out a red pill. |
| PATIENT | Let me take this pill. |
| | She puts the pill in her mouth, chews, grimaces but swallows. |
| | (grimacing, to the audience) |
| PATIENT | it is also bitter. |
| | She coughs again. |
| | Let me take this cough mixture. |
| | She takes a sip of the cough mixture, swallows some |
| | and sprays the rest, making raspberry noises. |
| PATIENT | (to the audience) |
| | It is also bitter - very bitter. |
| | She gestures to throw away the medicine, thinks |
| | better of it, then exits. |

THE END

APPENDIX D
Sandwich

| | |
|---|---|
| Story Line | Sandwich making and eating together |
| Characters | Two sisters - Elder Sister (ES) and Younger Sister (YS) |
| Story | A girl (YS) comes home very hungry. Mum is not home, elder |
| | sister (ES) is. The hungry girl eats bread, then demands a |
| | sandwich. The elder sister offers her a cheese sandwich, a |
| | cucumber and a cucumber sandwich, one after another. YS |
| | changes her mind repeatedly, then decides to make herself a |
| | tomato sandwich. The elder sister eats up the tomato, sliced |
| | by the girl for the sandwich. Fortunately, there is another |
| | tomato for the tomato sandwich. |
| | They sit down to eat together. The elder sister teaches the girl |
| | table manners - no elbows on the table. Then, they get into the |
| | fun of dropping food and spilling water. Elder sister is turned |
| | off by the girl's noisy chewing and forces her to close her |
| | mouth while eating. The girl tricks the sister to play a game - |
| | I close my eyes; you close yours. The girl pours water over |
| | the head of the elder sister. |
| Props | - Bread, cheese slices for sandwich, cucumber-1, firm |
| | tomatoes-2, water bottle, plastic cups and plates - 2 each, |
| | - Peeler, small knife, small chopping board, |
| | - Tissues, plastic gloves, Optional: white table linen |
| | - Optional: School bag, school uniform for Younger Sister |
| Run Time | 4.5 minutes |
| Key Items | Beat 1: Mum, hungry, bread |
| | Beat 2: sandwich, cheese, like |
| | Beat 3: cucumber, peel, gloves |
| | Beat 4: slice, tomato, |
| | Beat 5: table, elbow, drop |
| | Beat 6: water, spill, eye |

| | |
|---|---|
| | Beat 1: Mum, hungry, bread |
| | - Elder Sis is browsing a magazine on sofa. There is a dining table |
| | with food (see Props) on it. |
| | - Enters Younger Sis. She has come home from school or playground. |
| | She shouts for the Mum. |
| YS | Mum, Mum. ... Where is Mum? |
| ES | (looks up) |
| | Huh ... Who? |
| YS | Mum. Where is Mum? |
| ES | Mum? Oh, Mum ... I don't know. |
| | (strokes tummy, sighs) |
| | I am hungry ... very hungry. |
| | YS goes to the table. Impatiently, opens the bread pack |
| | and takes a big bite into the bread. |
| ES | (shouts) |
| | You are hungry? |
| YS | Very hungry. |
| ES | What are you eating? |
| | (Holds up the bread slice) |
| YS | Bread. |

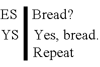

| | |
|---|---|
| | Beat 2: sandwich, cheese, like |
| | Shortly, YS finds it hard to swallow the dry bread |
| YS | I want a sandwich. |
| | ES gets up reluctantly, walks to the table, makes a |
| | quick cheese sandwich that she gives to YS. |
| ES | Sandwich. |
| | YS opens the sandwich like a crocodile opens its jaws. |
| | She takes out the cheese and holds it up. |
| YS | What is this? |
| ES | It is cheese. |
| YS | Cheese? |
| ES | Yes, cheese. |
| | YS puts back the cheese, holds up the sandwich. |
| YS | It is a cheese sandwich. |
| ES | Yes, it is a cheese sandwich. |
| | YS takes a bite, chews tentatively, spits into a tissue, |
| | thrusts the sandwich to ES. ES takes a bite. |

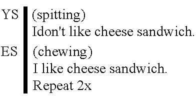

| | |
|---|---|
| | Beat 3: cucumber, peel, gloves |
| | ES picks up the cucumber. |
| ES | Do you want a cucumber? |
| YS | Yes, I want the cucumber. |
| | ES takes the cucumber, picks up the peeler, and starts peeling it. |
| YS | What are you doing? |

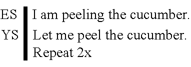

| | |
|---|---|
| | ES ignores YS, and puts the peeled cucumber on a plastic plate. |
| | She looks at her wet hands. |
| ES | Ah, my hands! |
| | ES holds up plastic gloves. |
| ES | Gloves ... I should put on the gloves. |
| | ES wipes her hand dry, puts on a glove on one hand, |
| | holds up her hand and wriggles her fingers. |
| YS | I want to put on the glove too. |
| | - YS wears the glove. |
| | - ES offers the peeled cucumber to YS. |
| YS | I don't want the cucumber. I want a cucumber sandwich. |
| | Beat 4: slice (noun & verb), tomato, |
| ES | Ok, let me slice the cucumber. |
| | ES slices the cucumber on the board, puts the slices |
| | between two pieces of bread and offers to YS. |
| ES | Cucumber sandwich. |
| YS | I don't want cucumber sandwich. |
| ES | What! |
| | YS holds up a tomato, smiles cheekily. |
| YS | What is that? |
| ES | Tomato. |
| YS | Tomato - right! I want tomato sandwich. |
| | (annoyed) |
| ES | You slice the tomato. |
| YS | Ok, I can slice the tomato. |
| | She slices the tomato slowly, pushing the slices to the edge of the |
| | chopping board. |

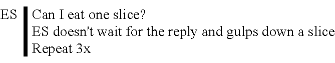

| | |
|---|---|
| | YS cuts the last slice, raises her head and discovers that there is |
| | just one slice left, the one in her hand. |
| YS | You ate all the slices! |
| | YS cries. Alarmed, ES makes a sandwich quickly. |
| ES | One more tomato here. Slice, slice, slice. Bread, tomato, bread. Here |
| | is the tomato sandwich. |
| | Beat 5: table, elbow, drop |
| ES | I am hungry too. |
| YS | You eat cucumber sandwich. I will eat tomato sandwich. |
| ES | Let us move the table here. |
| | They try to move the table but fail. |
| YS | We cannot move the table. |
| ES | We cannot move the table. |
| YS | Let us eat. |
| | They start eating. YS′ elbows are on the table. |
| ES | Your elbows! |
| YS | What? |
| | ES raises her own elbow and pats it. |
| ES | Elbows ... don't put elbows on the table. |
| | YS obeys but now ES has her elbows on the table. |
| | (admonishingly) |
| | Don't put elbows on the table. |
| | ES obeys. A slice of tomato drops from the sandwich. |
| ES | You dropped the tomato. |
| | A slice of cucumber drops from the sandwich. |
| YS | You dropped the cucumber. |
| | Another slice of tomato drops from the sandwich. |
| ES | You dropped the tomato again. |
| | YS pushes a tissue off the table. |
| YS | I dropped the tissue. |
| | Both laugh and give a high five to each other. |
| | Beat 6: water, spill, eye |
| ES | Give me some water. |
| | ES pours water to the glass; spills some. |
| YS | You spilled water. |
| | While drinking YS spills some water on herself. |
| ES | You spilled water. |
| | (laughs) |
| | I spilled water. |
| | YS chews noisily. YS thinks it funny, ES does not. |
| ES | Close your mouth. |
| | YS defiantly opens her mouth making a display of half-chewed |
| | sandwich. Repulsed, ES gets up, puts one hand on YS′ head, one |
| | under the chin and pushes mouth shut. |
| ES | Close your mouth. |
| | YS opens her mouth again. ES looks away. |
| YS | You close your eyes and I will close my mouth. |
| ES | You close your eyes! |
| | YS closes her eyes. |
| YS | Now, you close your eyes. |
| | ES closes her eyes. YS peeks at her, quietly gets up, |
| | pours water on ES′ head! ES jumps to her feet. |
| | (innocently) |
| | I spilled water. |
| | The door bell rings. YS is scared; ES emboldened. |
| YS | Mum! |
| ES | M-o-th-e-r |

THE END

APPENDIX E
Blindman's Bluff

| | |
|---|---|
| Story Line | Drawing with eyes closed; playing Blindman's Bluff; making |
| | new rules of movement: behind a line, inside a square; falling |
| | down |
| Characters | Two friends, Betty and Linda |
| Story | Linda boasts that she can draw an apple with eyes closed. |
| | Betty decides to test her by putting a blindfold on her. |
| | The blindfold gives Linda an idea to play Blindman's |
| | Bluff. Betty becomes ‘it’. Linda dodges and runs around, |
| | behind the table, behind the chair. Betty cannot catch her |
| | and wants to quit. Linda agrees not to run all over and |
| | stay behind a line drawn by Betty. Soon, Linda is caught. |
| | Linda becomes ‘it’ but wants Betty to be inside a square, a |
| | large one though. Betty cheats by stepping out of square |
| | several times. During the play, she trips and falls down. |
| | They have fun re-enacting the fall till they get tired. |
| Props | Whiteboard (small, portable), whiteboard eraser, |
| | whiteboard marker, blindfolds-2 (one for each sister) |
| Attire | Both should wear trousers to re-enact the falls (Beat 6). |
| Run Time | 4 minutes |
| Key Items | Beat 1: draw (sketch) |
| | Beat 2: see, catch (person) |
| | Beat 3: where (person), here, behind |
| | Beat 4: please, line |
| | Beat 5: square, inside |
| | Beat 6: fall, like (similar) |
| Special | Beat 1: Blindman's Bluff is known in different countries by |
| Notes | different names: Blind Hen, Blind Cat, Blind Cow, Blind Fly, |
| | Blind Buck etc. Use the English equivalent of the local name |
| | for the game. |
| | Beat 4: The line to confine the player to a narrow strip |
| | can be drawn against the wall or in front of a table. |

| | |
|---|---|
| | Beat 1: draw (sketch) |
| | Betty doodling on white board. Linda enters... |
| LINDA | You are drawing. |
| | Betty acts bashful and quickly erases all. |
| LINDA | Can you draw? |
| BETTY | Draw what? |

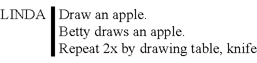

| | |
|---|---|
| BETTY | Can you draw? |
| LINDA | Draw what? |
| BETTY | An apple. |
| LINDA | (arrogantly) |
| | I can draw an apple with my eyes closed. |
| BETTY | (Challenges) |
| | Ok, close your eyes and draw an apple. |
| | Linda draws. Betty catches her peering, takes |
| | out a blindfold and puts on Linda... |
| LINDA | What are you doing? |
| BETTY | Now you draw. |
| | Linda takes off the blindfold, jumps... |
| LINDA | Let's play Blindman's Bluff |
| BETTY | Ok. |
| | Beat 2: see, catch (person) |
| | Betty puts on the blindfold. She volunteers to be ‘it’. |

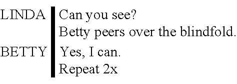

| | |
|---|---|
| | Linda adjusts the blindfold... |
| LINDA | Can you see now? |
| BETTY | No, I cannot see. |
| | Linda slowly backs away, runs and shouts... |
| LINDA | Catch me. |
| | Linda moves with hands extended |

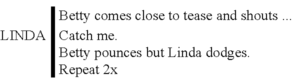

| | |
|---|---|
| | Beat 3: where, here, behind |
| BETTY | Where are you? |
| LINDA | I am here. |
| BETTY | Where? |
| LINDA | Behind the table. |
| | Betty goes behind the table. |
| | Linda runs behind the chair. |
| BETTY | Where are you? |
| LINDA | I am here. |
| BETTY | Where? |
| LINDA | Behind the chair. |
| | Betty goes behind the chair but cannot catch. |
| | Linda runs away. |
| | Betty takes off the blindfold... |
| BETTY | (pouts) |
| | I cannot catch you. I don't want to play. |
| | Beat 4: Dlease. line |

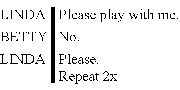

| | |
|---|---|
| BETTY | Ok, I will play again. But you don't run around. |
| LINDA | Ok, I can draw a line. |
| | Linda stoops to draw. |
| BETTY | What are you drawing? |
| LINDA | (looks up) |
| | A line. I will stand behind this line. |
| BETTY | Let me draw the line. |
| | Betty erases and draws another line giving her much narrower |
| | space. |
| BETTY | You must stand behind this line. |
| | Betty puts back the blindfold on herself. |
| LINDA | Catch me. |
| | Linda attempts to dodge but she can move mostly sideways |
| | behind the line and gets caught very soon. |
| | Beat 5: square, inside |
| | Betty takes off the blindfold. |
| BETTY | Your turn. |
| | Linda stoops down to draw a large square. |
| BETTY | What's that? |
| LINDA | It's a square. You have to stand inside the square. |
| | Linda puts on the blindfold. |
| BETTY | (shouts) |
| | Catch me. |
| | Betty dodges Linda by squatting down and sometimes by |
| | cheating - ie, stepping out of the square but when Linda asks... |

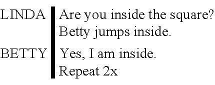

| | |
|---|---|
| | Beat 6: fall, like (similar) |
| | Betty, to dodge Linda, bends backward, staggers and falls down. |
| | Linda takes off the blindfold. |
| LINDA | What happened? |
| BETTY | I fell down. |
| LINDA | How did you fall? |
| | Betty re-enacts the fall... |
| BETTY | Like this. |
| | Linda laughs at the clumsy re-enactment. Betty laughs too. |

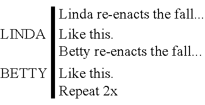

| | |
|---|---|
| | They get tired and once, when they fall, they |
| | stretch out and don't get up. |
| LINDA | I want to sleep. |
| BETTY | Me too. |

THE END

APPENDIX F
Hot Tea on a Cold Rainy Day

| | |
|---|---|
| Story line | Heavy rain, daughter coming home to a Mom waiting |
| | anxiously, drying hair, unable to hear in the din of hair dryer, |
| | wearing a sweater, making tea, dropping the spoon, getting |
| | the finger burned |
| Characters | Mother (“M”) and daughter (“G” for girl) |
| Story | A girl is gone out in the heavy rain. Her Mom is anxiously |
| | waiting for her. Finally, she comes home. She puts the |
| | umbrella in a corner and takes off her raincoat. Her hair is |
| | wet. She towels her hair. It's still wet. She blow dries it. Mom |
| | asks her if she wants tea but the girl cannot hear her in the din |
| | of the hair dryer. After she has dried her hair, she starts |
| | feeling cold and wears a sweater. Then, she gets step-by-step |
| | instructions from her Mom for making tea. The girl finds her |
| | cup of tea not sweet enough. She keeps adding sugar in her |
| | cup. Mom tells her to stop and mix the sugar. But the only |
| | spoon gets dropped on the floor. Mom blames the girl. Angry, |
| | the girl uses her finger to stir her tea and burns her finger. |
| | Mom applies cream on it. |
| Props | Umbrella, raincoat, towels-2, hair dryer, electric water kettle, |
| | teacups-2, teaspoon-1, Sugar, milk in pots, teabags-4, |
| | cream tube-1 |
| Make Up | Index finger of the girl is made reddish with Potassium |
| | Permanganate solution 0.1% making it appear burned. |
| Sound | Electronic sound file attached. Double click on it for sound of |
| | rain. [symbol] |
| Run time | 4 minutes |
| Key Items | Beat 1: rain, umbrella, corner |
| | Beat 2: wet, hair, towel |
| | Beat 3: dry, hear |
| | Beat 4: cold, sweater |
| | Beat 5: tea, cup, next |
| | Beat 6: add, sugar, sweet (taste) |
| | Beat 7: mix, spoon, drop |
| | Beat 8: finger, burned, cream |
| Special | Beat 4: Sweater = jumper = pullover. In some countries, the |
| Note | term ‘sweater’ (which has no front opening) may be used |
| | loosely to refer to ‘cardigan’ (fastened at the front). Follow |
| | the local usage but use one and only one most common word |
| | (sweater or jumper or pullover.). |
| | Beat 8: Water in the kettle is not actually very hot. |

| | |
|---|---|
| | Beat 1: rain, umbrella, corner |
| | It's raining heavily outside and a worried Mom is pacing up and |
| | down. |
| M | (straining her neck) |
| | Its raining. ... It's raining. |
| | Thunder ceases. Mom listens - it's quiet. |
| M | It's not raining now. It stopped. |
| | Bursts in a girl in a wet raincoat, carrying a folded wet umbrella. |
| | Her hair and face have got wet despite the umbrella. |
| G | Mom. |
| M | (relieved) |
| | Ah, you came back. |
| | It was raining. ... Umbrella, Mom, where should I keep the umbrella? |
| | Mom offers to take the umbrella but steps back as it is wet. |
| M | Give the umbrella to me. ... Oh no, put it in the corner. |
| G | Which corner? This corner? |
| M | No, not there. Put it in that corner. |
| | Beat 2: wet, hair, towel |
| M | Take off your raincoat. |
| G | It's wet. |
| | Mom takes the raincoat and hangs it on a peg/ the back of a chair. |
| M | Your hair is wet. |
| | (touches hair) |
| | Yes, it is wet. Give me a towel. |
| | Mom offers a towel. |
| G | This is yours towel. Give me my towel. |
| | The girl towels her hair. |
| | Mom touches her hair, then wipes her hand with a tissue paper. |
| M | Your hair is still wet. |
| | Beat 3: dry, hear |
| | Mom picks up a hair dryer. |
| M | Dry your hair. |
| | The girl takes the dryer, turns it on. It hums softly. Mom sits down |
| | and opens a magazine. After few seconds, she asks the girl ... who |
| | cannot hear due to the dryer noise (though audience can). |

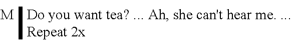

| | |
|---|---|
| M | (Screams) |
| | Do you want tea? |
| | Girl looks up, realizes Mom is saying something, |
| | smiles innocently, continues drying her hair. |
| | (loud, touching back of an ear) |
| G | I can't hear you. |
| | The girl switches off the dryer. |
| G | Yes, Mom, I can hear you now. |
| M | (touches her hair) |
| | It's dry. |
| | (touches the hair) |
| G | Yes, it's dry. |
| | Beat 4: cold, sweater |
| | Suddenly, the girl starts feeling cold, maybe getting wet is going to |
| | make her ill. She hugs herself first, then starts shivering. |
| G | Mom, It's cold. ... I am feeling cold. ... I am cold. |
| M | Oh, you are feeling cold? |
| G | Yes, Mom. Get me a sweater please. |
| | Mom gets her a sweater. |
| M | Here is the sweater. |
| | The girl wears the sweater. |
| G | Thanks. It's a nice sweater. ... I am not cold now. |
| | Beat 5: tea, cup, next |
| | Mom picks up a tea cup, puts two teabags in it. |
| M | Do you want tea? |
| G | Yes. |
| M | Come here. You make tea. |
| G | Give me the cup. |
| | Mom gives two cups. |
| M | Your cup ... and my cup. |
| G | What do I do next? |
| | Mom points to the electric kettle. |
| M | Get some water. |
| | The girl gets some water in the two cups. |
| G | Next? |
| M | Next, you put teabags in the water. |
| | Beat 6: add, sugar, sweet (taste) |
| G | Next? |
| M | Next, you add milk. |
| C | Next? |
| M | Next, you add some sugar. |
| G | Next? |
| | Mom picks her cup. |
| M | The tea is ready. |

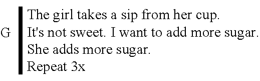

| | |
|---|---|
| | Beat 7: mix, spoon, drop |
| | Mom has been watching amused. Now, she stops her. |
| M | Hey, you have to mix it. |
| | She gets a teaspoon and stirs her own cup. |
| M | Mix, mix, mix. |

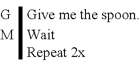

| | |
|---|---|
| | Mom passes the spoon to the girl but the spoon drops on the floor. |
| G | Oh, Mom, you dropped the spoon! |
| M | No, I did not drop it. You dropped it. |

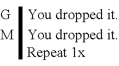

| | |
|---|---|
| | Beat 8: finger, burned, cream |
| | Silence. The girl is incensed. She gestures to stir with her index |
| | finger... |
| G | (haughtily) |
| | I don't need the spoon. ... I can use my finger. |
| M | Don't! |
| | The girl dips her finger in her cup. The water is scalding hot. |
| G | Ouch, my finger! |
| | She prances about for a while. |
| | Mom examines her finger. It's red. She blows on it. |
| M | Your finger is burned. |
| G | (sobs) |
| | My finger ... is burned. |
| | Mom takes a medical cream tube from a cabinet/box. |
| M | Put some cream on it. |
| G | Ok, put cream on it. |
| | Mom applies the cream generously. |
| | They look each other. Mom smiles affectionately. |
| G | Mom ... I love you. |

The End

APPENDIX G
Apple Thief - R&E Skits

T1 = Teacher-Actor1
T2 = Teacher-Actor2
give

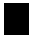

T1: Give me an apple.
T2 gives an apple.

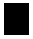

T1: Give me a knife.
T2 gives a knife.

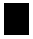

T1: Give him a pencil.
T2 gives a pencil to a student.
want

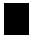

T1 offers various toy fruits to T2...
T1: What do you want?
T2: I want an apple.
T1 gives an apple to T2.

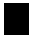

T1 offers an apple...
T1: Do you want the apple?
T2: Yes, I want the apple.
T1: I want some cream.
T2 offers the tube/jar. T1 takes some cream and rubs on her hands.
apple

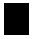

There are few toy fruits on the table.
T1: Give me an apple.
T2 gives the apple.

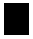

T1 offers an apple...
T1: Do you want the apple?
T2: Yes, I want the apple.

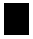

T1 offers an apple...
T1: Do you want the apple?
T2: No, I don't want the apple.
what
T1 taps the shoulder of T2 from behind.
T2: What?
T1: Nothing.

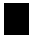

T1 offers various toy fruits to T2...
T1: What do you want?
T2: I want an apple.
T1 gives an apple to T2.
T1 oblivious to her surroundings looks in the mirror and makes faces.
T2: What are you doing?
T1 is embarrassed.
mine
T1 finds a coin from the floor picks up and examines it.
T2: It is mine.
T1 picks up a pen from the table to write. T2 snatches it...
T2: It's mine.
T2 and T1 sitting at a table. Absent-mindedly, in order to make room on
the able, T1 pushes two stacks of books off the table. They stoop to pick
the books.
T1: This is mine. ... This is not mine.
T2: This is mine. ... This is mine.
no

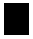

T1 taps on T2's shoulder...
T1: Are you Mr. ---?
T2: No. I am ---.

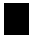

T1 asks T2 something in the local (or, other than target) language.
T2 looks puzzled. T2 then asks in target language...
T1: Do you speak --- (name of the language)?
T2: No. I don't speak ---.

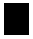

T1 offers candy...
T1: Do you want a candy?
T2: No.
let go

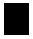

T1 and T2 are measuring the length of the table with the measuring tape.
T2 drops her end and picks up two times.
T1: (annoyed) Don't let go.
T1 measures the length and wants to fold back the tape.
T2 holds the tape tight.
T1: Let go.
T2: Oh, ok.
T1 and T2 grab an object (pencil/book) from the table at the same time.
T1: Let go.
T2 lets go of the object...
T1 grabs T2's hand.
T2: (angrily) Let go.
T1 lets go of the hand.
yes

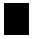

T1 points to a bag with an apple inside...
T1: Is there an apple?
T2 takes out and holds the apple...
T2: (nods) Yes.

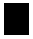

T1 points to a knife in a sheath...
T1:Is that a knife?
T2 takes out and holds the knife...
T2: (nods) Yes.

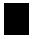

T1 offers candy...
T1: Do you want a candy?
T2: Yes.

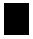

T1 taps on T2's shoulder...
T1: Are you Miss ---?
T2: (shakes hands) Yes, yes. I am Miss ---
cut

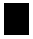

T1 spreads a string...
T1: Cut it.
T2 cuts the string with a pair of scissors.

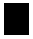

T1 offers toy fruits whose two halves are attached with Velcro hook and
loop fastener.
T1: Cut this.
T2 cuts it.
Repeat with two fruits
some

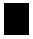

T1: Give me some candy.
T2 offers the whole bag.
T1 declines the bag, she wants only some...
T1: Give me some.
T2 gives some candies to T1.

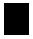

T1: I want some cream.
T2 offers the whole tube/jar.
T1: Oh, give me some.
T1 takes some cream and rubs on her hands.

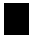

T1 opens a Coke can.
T1: Do you want Coke?
T2: No. ... Ok give me some.
T1 pours some in T2's glass.
cannot

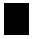

T1 offers a dry white board marker to T2.
T1: Write your name.
T2 tries but the marker is quite dry...
T2: I cannot write with it.

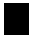

T1: Open the bottle.
T2 tries and fails.
T1: You cannot open it.

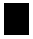

T1: (winks) Can you close one eye?
T2 tries to wink but closes both of her eyes.
T1: (laughs) You cannot.
can
T1 tries to open a bottle but fails.
T1: I cannot open it.
T2 takes the bottle and opens it.
T2: I can.

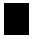

T1: (winks) Can you close one eye?
T2, after two unsuccessful attempts, winks.
T2: I can.

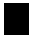

T1 touches a high spot on the wall.
T1: Can you touch it?
T2 tries and fails.
T2: I cannot.
T1: I can.
small

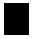

T1: Give me the small ball.
T2 offers bigger of the two balls.
T1 picks up the small ball...
T1: No, I want the small ball.
T1: Give me a cup/glass.
T2 offers bigger of the two cups/glasses.
T1: Give me the small cup/glass.
T2 gives the small cup.
T1: Do you want candy?
T2 picks up the big candy and pushes back the small one...
T2: I don't want the small one.
big

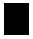

T1: Give me the big ball.
T2 offers smaller of the two balls.
T1 picks up the big ball...
T1: No, I want the big ball.
T1: Give me a cup/glass.
T2 offers smaller of the two cups/glasses.
T1: Give me the big cup/glass.
T2 gives the big cup.
T1 offers a big candy...
T1: Do you want candy?
T2 picks up the small one and pushes back the big one...
T2: I don't want the big one.
knife

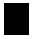

T1 is looking at a fruit (real or toy).
T1: Give me a knife.
T2 gives the knife. T1 takes the knife and cuts the apple.
T1 shows a small toy knife...
T1: I have a knife.
T1 brandishes a big toy knife...
T1: I also have a knife.
T1 has two table knives, T2 has two forks.
T1: I have two knives.
T2: I have two forks.
T1: You give me one fork. I will give you one knife.
They do the exchange.
try again

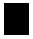

T1: Draw an elephant (or any animal).
T2 makes an ugly drawing.
T1 erases it...
T1: Try again.
Repeat 3x
T2: I don't want to try.
T1 gives a balloon to T1
T1: Blow it please.
T2 tries, fails, shakes his head.
T1: Try again.
Repeat 2x
T2 offers the balloon to T1...
T1: Now you try.
try
T1 tries to open the bottle but fails.
T2: Let me try.
T1: Open it please.
T2: I am trying!
Finally T2 succeeds.

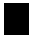

T1 puts on a cap/glasses, takes off and offers to T2
T1: You want to try!
T2 accepts the offer and tries.

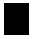

T1 eats a candy from a candy pack, offers one to T2...
T1: Do you want one?
T2: No.
T1: Try one.
T2 accepts.
again

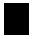

T1: What's your phone number?
T2: 6789-5432
T1: Tell me again.
T2: 6789-5432
Repeat 2X
T1: Thanks.

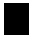

T1: Count to five.
T2: 1, 2, 3, 4, 5.
T2: Count again
Repeat 2x
you
T1 and T2 play with a ball.
T1: Get the ball.
T2: You get the ball.
T1: You get the ball.
T2: Ok.
T1 is sitting on the sofa. She gets up to get a magazine.
T2 quickly occupies the sofa. T1 stands over T2, arms akimbo...
T2: Sit there.
T1: (upset) You sit there.
T2: You sit there.
Repeat 2x
T2 finally gets up.

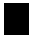

T1 is sitting on a chair.
T2: Hey, you!
T1 looks up, looks around, looks at T2 puzzled.
T2 asks him to exchange the seat with a student...
T1: Yes, you. You sit there. And you. You sit there.
for
T1: This book/pencil is for you; this one, for me; this one, for Irma
(a student).
for you
T1 distributes color pencils or candies.
T1: This one is for you, this one for me, this one for you, this one for me,
this one for you, this one for me.
thank
T1: Give me your pen.
T2 takes out the pen from her pocket and gives to T1.
T1: Thank you.

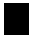

T1: Do you want a candy/cookie?
T2 accepts quietly.
T1: Say, Thank you.
T2: Thank you.
T1 takes out a tissue from the pocket and drops a coin.
T2 picks it up and gives to T1.
T1: Thank you.
enough

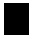

T1 pours the water to a cup held by T2.
T1: (pauses) Enough?
T2: Not enough,
Repeat 2x
T1 pours water to the brim...
T1: Enough?
T2: Enough, enough!
T1 gives a handful of wrapped candies to T2, and offers more...
T1: Do you want more.
T2: No, this is enough.
not

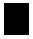

T1 points to a bag with an apple inside...
T1: Is there a banana?
T2 takes out and holds the apple...
T2: (nods) No, it's not a banana. It's an apple.

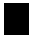

T1 taps on T2's shoulder...
T1: Are you n a m e
T2: No, I am not n a m e.
T1 is writing.
T2 picks up an eraser/pencil...
T1: Can I take it?
T2 snatches the eraser/pencil...
T2: No, you cannot.
don't

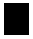

T1 offers a candy...
T1: Do you want the candy?
T2: No, I don't want the candy.

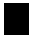

T1 asks T2 something in the local (or, other than target) language.
T2 looks puzzled. T2 then asks in target language...
T1: Do you speak (name of the language)?
T2: No. I don't speak
T1: Do you want candy?
T2 picks up the big candy and pushes back the small one...
T2: I don't want small one.
T1: Draw an elephant (or any animal).
T2 makes an ugly drawing.
T1 erases it...
T1: Try again.
T2: I don't want to try.
take

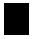

T1 is writing.
T2 picks up an eraser/pencil...
T1: Can Itake it?
T2: Yes, you can take it.

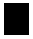

T1 offers few candies...
T1: Take some.
T2 picks up one and hesitates over the second one with her hand
hovering...
T1: Take it, take it.
T1: Bye, bye.
T2 picks up a bag and gives to T2...
T2: Take your bag.
have
T1 takes out a dollar from her pocket...
T1: I have one dollar.
T1 takes out two dollars from her pocket...
T2: I have two dollars.
T1 holds up an apple...
T1: I have an apple.
T2 holds up a knife...
T2: I have a knife.

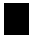

T1: Do you have a pen?
T2 rummages in her pocket, comes empty-handed...
T2: I don't have a pen.
T1 takes out a pen...
T1: Oh, I have a pen.
say

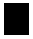

T1: Say, Hi!
T2: Hi
Repeat with Hello. Bye.
my
Of the two books on the table, T1 and T2 pick one each...
T1: This is my book.
T2: This is my book.
Repeat with pairs of pens and candies.
this

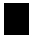

T1 points to a table...
T1: What is this?
T2: This is a table.
Repeat with chair, apple, knife.
tell

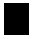

T1: Tell me your name.
T2 tells her name.

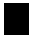

T1 points to a student...
T1: Tell me her name?
Repeat with two more students
T1 writes ‘9 + 7 = ?’ on the white board...
T2: Nine plus seven is...
T1: Don't tell me. Don't tell me. 9 + 7 is ... 9 + 7 is 16.

APPENDIX H
Type 1 Display Substitute for Stage Prompter
Apple Thief
KEY ITEMS

| | |
|---|---|
| Beat1: | apple, what, mine |
| Beat2: | give me, no |
| Beat3: | let go |
| Beat4: | you, take it |
| Beat5: | want, yes |
| Beat6: | cut, some |
| Beat7: | knife, cannot, small, big |
| Beat8: | cannot, try again |
| Beat9: | for you, thank you |
| Beat10: | enough, don't want |

APPENDIX J
Type 2 Display Substitute for Stage Prompter

| | |
|---|---|
| | Beat7: small knife, big knife, cannot |
| | Owner takes out a tiny knife and holds it up. |
| THIEF | You have a knife! |
| OWNER | Yes, I have a knife. |
| | The knife is tiny. Owner tries to cut the apple but fails. |

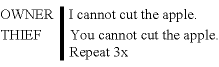

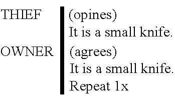

| | |
|---|---|
| | Thief pulls out a big (plastic) knife. |
| THIEF | I have a big knife. |
| OWNER | Wow, you have a big knife. |
| | (brandishes knife) |
| THIEF | I have a big knife. |

[image] [image] [image] [image] [image] APPENDIX M
Illustration of Similarities between L1 Acquisition and the
Inventive Methods (in accordance with at least one embodiment)

| Feature | First Language Acquisition | Inventive Methods |
|---|---|---|
| Comprehensibility | Caregivers model their speech to the child's | The “theater of life” plays and “reinforcement |
| | level in order to be understood as per their | and expository” skits are scripted to ensure that |
| | understanding of the child's cognitive and | each dialog provides comprehensible speech input |
| | linguistic competence. | to the student. The key language items |
| | | (vocabulary, syntax) as well as the themes of the |
| | | plays accord with the students' learning levels. |
| | If the message is not understood by the child, | In a “theater of life” play, within a beat, each key |
| | the caregivers repeat, rephrase and expand it. | language item is repeated in dialogs several |
| | | times. In subsequent beats, the language item may |
| | | recur. The reinforcement and expository sessions |
| | | further confirm, clarify or correct the meaning of |
| | | the item by using it repeatedly in isolated |
| | | contexts. |
| | The caregivers' steer clear of complex topics. | The “theater of life” plays deal with ‘here and |
| | Their message concerns ‘here and now’ (not in | now’, which happen to be easier to deal with on |
| | the neighborhood; not yesterday). | the stage. |
| Extra-linguistic clues | The caregivers often provide speech input along | The “theater of life” lessons carefully plan such |
| | with a sensory experience (showing a physical | sensory experiences for each key language item |
| | object, imitating an action). The ‘here and now’ | |
| | nature of their language facilitates provision of | |
| | sensory experiences. | |
| | The caregivers use exaggerated gestures, | The teacher-actors in a “theater of life” play and |
| | expressions and tone of their voice in order to | reinforcement and expository skits use |
| | facilitate comprehension of novel language | exaggerated gestures and tones to ensure that |
| | items (vocabulary or syntax). | each key language item whether in a play or skit |
| | | is understood by the students. |
| Effortless & | A child does not consciously learn the first | The exposure to “theater of life” makes the |
| Inevitable | language. It just happens and it inevitably | acquisition of foreign language inevitable without |
| | happens as long as the child is exposed to | conscious efforts on the part of the students. |
| | comprehensible speech input. | |
| Sequencing | There is no crash course for the first language. | The linguistic and plot complexities of the plays |
| | The caregivers help the child advance one step a | progress through the students' learning levels in a |
| | time by including slightly and only slightly | systematic manner. |
| | higher level of language. | |
| | A child's speech grows from being very simple | The reinforcement and expository lessons require |
| | to complex - progressing from one word, two | calibrated participation progressing from simple |
| | words utterances to complex sentences. | (one, two words) to complex (full sentences). |

1. A method of providing instruction of a target language to one or more students whose native language is different from the target language, said method comprising the step of presenting dramatic interactions between at least two teacher-actors, wherein each dramatic interaction:
includes pre-scripted dialog primarily in the target language between the at least two teacher-actors, the pre-scripted dialog involving delivery of a plurality of preselected target language items; and
includes embellishments to the pre-scripted dialog, the embellishments being adapted to facilitate comprehension of the plurality of preselected target language items on the part of the one or more students;
wherein the pre-scripted dialog and embellishments thereto are configured for recreating a learning environment akin to childhood first language acquisition.

2. The method according to claim 1, wherein the embellishments comprise at least one of the following associated with the preselected target language items:
tangible props to be manipulated by at least one teacher-actor or student;
tangible props to be referred to by at least one teacher-actor or student;
visual depictions;
sound effects;
repetition;
exaggerated gesturing; and
exaggerated intonation.

3. The method according to claim 1, wherein the embellishments comprise extra-linguistic clues.

4. The method according to claim 1, wherein said target language items comprise vocabulary items.

5. The method according to claim 1, wherein said target language items comprise between about 10 and about 20 lexemes.

6. The method according to claim 5, wherein the lexemes are selected from at least one set of high frequency lexemes.

7. The method according to claim 6, wherein the lexemes are graded in accordance with an instructional level intended for the one or more students.

8. The method according to claim 1, wherein said plurality of target language items have previously not been taught to the one or more students.

9. The method according to claim 1, wherein the dramatic interactions comprise a play and at least one skit.

10. The method according to claim 9, wherein the play involves a plot or story line for enhancing student retention and recall of the at least one target language item.

11. The method according to claim 9, wherein the play comprises a plurality of segments each associated with at least one target language item.

12. The method according to claim 11, wherein each of the segments is associated with between about one and about five target language items

13. The method according to claim 9, wherein the at least one skit comprises limited dialog, the limited dialog comprising sentences involving the repetition of at least one target language item in the sentences.

14. The method according to claim 13, wherein the limited dialog is configured for student participation, whereby the resultant direct, personal experience enhances student retention and recall.

15. The method according to claim 9, wherein each skit is associated solely with one target language item.

16. The method according to claim 9, wherein the play and at least one skit are related via at least one target language item.

17. The method according to claim 16, wherein each skit is related to the play via at least one target language item.

18. The method according to claim 16, wherein the at least one skit comprises a plurality of skits, further wherein said skits in sum involve all target language items from the play.

19. The method according to claim 1, wherein dialog between the teacher-actors in each dramatic interaction is exclusively in the target language.

20. The method according to claim 1, wherein the delivery of target language items avoids the conscious teaching of grammar.

21. The method according to claim 1, wherein said presenting step comprises the at least two teacher-actors presenting the dramatic interactions live.

22. The method according to claim 1, wherein said presenting step comprises presenting the dramatic interactions via a multimedia arrangement.

23. The method according to claim 22, wherein the dramatic interactions are presented via a videocassette.

24. The method according to claim 22, wherein the dramatic interactions are presented via a DVD.

25. The method according to claim 22, wherein the dramatic interactions are presented via a video compact disc.

26. The method according to claim 22, wherein the dramatic interactions are presented via a film.

27. The method according to claim 22, wherein the dramatic interactions are presented via a television broadcast.

28. The method according to claim 22, wherein the dramatic interactions are presented via a computer.

29. The method according to claim 28, wherein the dramatic interactions are presented via the internet.

30. A multimedia arrangement for providing instruction of a target language to one or more students whose native language is different from the target language, said multimedia arrangement comprising an arrangement for presenting dramatic interactions between at least two teacher-actors, wherein each dramatic interaction:
includes pre-scripted dialog primarily in the target language between the at least two teacher-actors, the pre-scripted dialog involving delivery of a plurality of preselected target language items; and
includes embellishments to the pre-scripted dialog, the embellishments being adapted to facilitate comprehension of the plurality of preselected target language items on the part of the one or more students;
wherein the pre-scripted dialog and embellishments thereto are configured for recreating a learning environment akin to childhood first language acquisition.
